(19) United States
(12) Patent Application Publication
(10) Pub. No.: US 2003/0107557 A1
(43) Pub. Date: Jun. 12, 2003

(54) Control of unintended single-tap actuation of a computer touch pad pointing device

(75) Inventors: Frank W. Liebenow, Dakota Dunes, SD (US); Dean J. Dykstra, Sioux City, IA (US)

Correspondence Address: GATEWAY, INC., SCOTT CHARLES RICHARDSON, 610 GATEWAY DRIVE, MAIL DROP Y-04, NORTH SIOUX CITY, SD, 57049, US

(73) Assignee: Gateway, Inc.

(21) Appl. No.: 10/349,016

(22) Filed: Jan. 21, 2003

Related U.S. Application Data
(63) Continuation of application No. 08/902,813, filed on Jul. 30, 1997.

(51) Int. Cl. G09G 5/00

(52) U.S. Cl. 345/173

(57) ABSTRACT

The control of unintended actuation of a touch pad pointing device is disclosed. In one embodiment of the invention, a computerized system comprises a touch pad pointing device capable of actuation by a user, and a pointing device driver. The pointing device driver comprises a disable component, and a censor and re-enable component. The disable component sets a disable function upon detection of a disabling event. The censor and re-enable component ignores the single-tap actuation of the touch pad pointing device upon the setting of the disable function. Finally, the censor and re-enable component resets the disable function upon detection of an enabling event.

### FIELD OF THE INVENTION

This invention relates generally to a touch pad pointing device for a computer, and more particularly to providing for the control of unintended single-tap actuation of such a touch pad pointing device.

### BACKGROUND OF THE INVENTION

Because of the rising popularity of graphics-oriented operating systems for personal computers, such as Microsoft Windows, computer systems typically now include a pointing device. Desktop computers usually include a mouse pointing device. However, because the mouse is an inconvenient pointing device for users of laptop computers, laptops many times include an integrated touch-pad pointing device.

The touch-pad pointing device includes a touch-sensitive pad. By pressing down on the pad with a finger, the user is able to control the movement of a pointer on a display device of the computer. That is, the user causes the operating system to move the pointer on the screen by moving a finger on the pad in a corresponding direction. This pointer control with the touch pad is akin to moving a mouse pointing device on a level horizontal surface.

A touch pad typically also permits the user to perform an additional operation besides pointer movement. The user may “tap” on the touch-sensitive pad to cause the pad to send a signal to the computer to which it is coupled, like the signal sent by a mouse when one of its button has been pressed. That is, a “tap” on a touch-pad pointing device is akin to a “click” of a mouse button. Note that even in the case where a touch pad includes buttons, the user usually can “tap” on the touch-sensitive pad to have the pointing device send the same signal as it would if the user had pressed a button.

With respect to an integrated touch pad for a laptop computer, the touch pad usually is located just below the keyboard. This placement ensures that the user does not have to move his or her hands very far in accessing the touch pad after typing, or vice-versa. In fact, the placement permits the user to even use the touch pad without moving his or her hands from the keyboard, by using the touch pad with the thumb of either hand. Thus, the placement of the touch pad just below the keyboard is an advantageous location. Manufacturers of computer keyboards for desktop computers have also begun to manufacture keyboards for desktop computers that have integrated touch pads below their keys.

However, locating the touch pad just below the keyboard, either on a laptop computer or on a stand-alone keyboard for a desktop computer, has a glaring deficiency in that it promotes accidental and undesired actuation tapping of the pad when the user is typing. Thus, many users have difficulty with this touch pad placement because they find themselves frequently accidentally tapping the touch pad while typing. In a word processing program, for example, this single tap results in the text entry location changing (via relocation of a text-select cursor), forcing the user to stop what he or she is doing, and move the text entry location back to its proper place. In other programs, accidental single tapping may de-select the current program and select another program, which is also very frustrating for the user.

One solution to solve this problem is to turn off the touch pad through the basic input/output system (BIOS) program of a computer, or through a modified pointing device driver program. Through the BIOS or a modified pointing device driver, the user is able to disable the touch pad, and instead enable another pointing device, such as a mouse. Accidental single taps on the touch pad are then ignored by the operating system, and thus do not cause unintended and unexpected events.

However, this solution has a serious drawback in that the touch pad cannot then be used by the user without reenabling the touch pad in the BIOS or the modified pointing device driver. The advantage of having a touch pad below the keyboard in the first place is thus reduced. Most users will not continually switch the touch pad on and off, but instead may stop using the touch pad altogether, and instead use a mouse or other pointing device that is not integrated with the keyboard.

Therefore, there is a need to prevent accidental tapping on a touch pad from causing unintended and unexpected events. There is a need for such prevention that does not require the user to fully disable the pointing device through BIOS or a modified pointing device program. That is, there is a need for such prevention that does not compel the user to stop altogether using an integrated touch pad located below a keyboard.

### SUMMARY OF THE INVENTION

The present invention relates to the control of unintended single-tap actuation of a touch pad pointing device. A computerized system having a touch pad pointing device driver to prevent unintended actuation of a pointing device from causing an event on a computer is described herein. More particularly, in one embodiment the pointing device driver ignores single-tap actuation of the touch pad after the occurrence of a disabling event (such as the user having depressed a key on a keyboard of the computer), until an enabling event (such as the passage of a predetermined length of time) has occurred.

In this manner, the present invention prevents accidental taps on the touch pad from causing unintended and unexpected events when such accidental single taps are most likely to occur. A user is most apt to accidentally tap the touch pad when the user is typing on the keyboard. However, the invention in one embodiment ignores such tapping for a predetermined length of time after the user has pressed a key on the keyboard, or another enabling event has occurred. Thus, the touch pad is never fully disabled, and the user is not required to re-enter the BIOS or a device driver every time the user wishes to use the touch pad. The present invention controls accidental taps without compelling the user to abandon use of the touch pad.

Other embodiments of the invention include a computerized system having a touch pad pointing device driver that comprises two different components. A disable component sets a disable function upon detection of a disabling event (such as the depression of a key on the keyboard). A censor and re-enabling component ignores single-tap actuation of the pointing device upon the setting of the disable function. Finally, the censor and re-enable component resets the disable function upon detection of an enabling event (such as the passage of a predetermined length of time). Still other and further aspects, advantages, and embodiments of the invention will become apparent in the following description, and by reference to the drawings.

### BRIEF DESCRIPTION OF THE DRAWINGS

FIG. 1 is a diagram of a computer in conjunction with which an embodiment of the present invention may be implemented;

FIG. 2(a) is a block diagram of the hardware aspects of a computerized system according to an embodiment of the invention;

FIG. 2(b) is a block diagram of the software aspects of a computerized system according to an embodiment of the invention;

FIG. 3 is a flow chart of a disable function of a pointing device driver program, according to an embodiment of the invention; and,

FIG. 4 is a flow chart of a censor and re-enable function of a pointing device driver program, according to an embodiment of the invention.

### DETAILED DESCRIPTION OF THE INVENTION

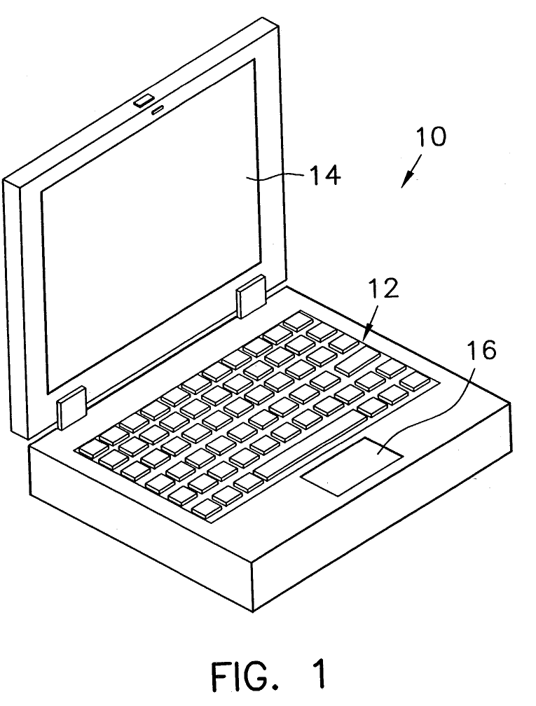

The present invention relates to the control of unintended actuation of a touch pad pointing device. A diagram of a typical computer in conjunction with which the present invention may be implemented is shown in FIG. 1. Computer 10 typically includes keyboard 12, display device 14 and touch pad pointing device 16. Not shown is that computer 10 typically includes a fixed media storage device such as a hard disk drive, and a removable media storage device such as a floppy disk drive and/or a CD-ROM drive. Also not shown is that computer 10 typically includes a random-access memory (RAM) (in one embodiment, sixteen megabytes), a central-processing unit (CPU) (in one embodiment, an Intel Pentium processor), and a read-only memory (ROM). As shown, computer 10 is a laptop computer, such as a Gateway 2000 Solo laptop computer, although the invention is not so limited. For example, computer 10 could also be a desktop computer such as a Gateway 2000 desktop computer.

Computer 10 typically has an operating system running thereon that coordinates activity by other computer programs, especially in conjunction with keyboard 12, display device 14, and touch pad pointing device 16. One such operating system is MS-DOS; another is Microsoft Windows. The operating system typically includes a pointing device driver program, as is understood by those of ordinary skill within the art, that controls the signals received by computer 10 from pointing device 16, and provides the signals to the other computer programs as necessary. As shown in FIG. 1, display device 14 is a flat-panel display device such as a liquid crystal display (LCD). However, the invention is not so limited; display device 14 can be any of a number of different devices.

Pointing device 16 as shown in FIG. 1 is a touch pad, having a touch-sensitive pad. The pad detects the positions at which the user is moving his or her finger on the pad, and conveys this information to the computer via a signal. The touch pad is also receptive to a user tapping the touch-sensitive pad, and conveys information regarding such tapping to the computer via a signal as well. In another embodiment, the touch pad also has one or more separate buttons, which the user may click, and information regarding which is sent to the computer also via a signal. Pointing device 16 may also be external to computer 10, or integrated with a different device, such as a stand-alone computer keyboard of a desktop computer, and still be within the scope of the invention.

The “clicking” or “tapping” of the pointing device (i.e., the actuation of the pointing device) by a user of the computer causes any number of different events to occur in the computer, depending on the type of program currently running on the computer. For example, in a word-processing program (such as Microsoft Word or Novell WordPerfect), a pointer controlled by the pointing device turns into a text-select cursor when it is moved over the text-entry area displayed on the display device, and thus has entered what is known as text-entry mode. Moving the cursor out of the area exits text-entry mode and changes the cursor back to a pointer. While in text-entry mode, however, tapping on the touch pad causes the position at which text entry will occur next to move or relocate to the location of the text-select cursor. This enables a user to quickly move the point of text entry within a document by using the touch pad, without having to use the cursor keys of the keyboard. This is understood by those of ordinary skill within the art.

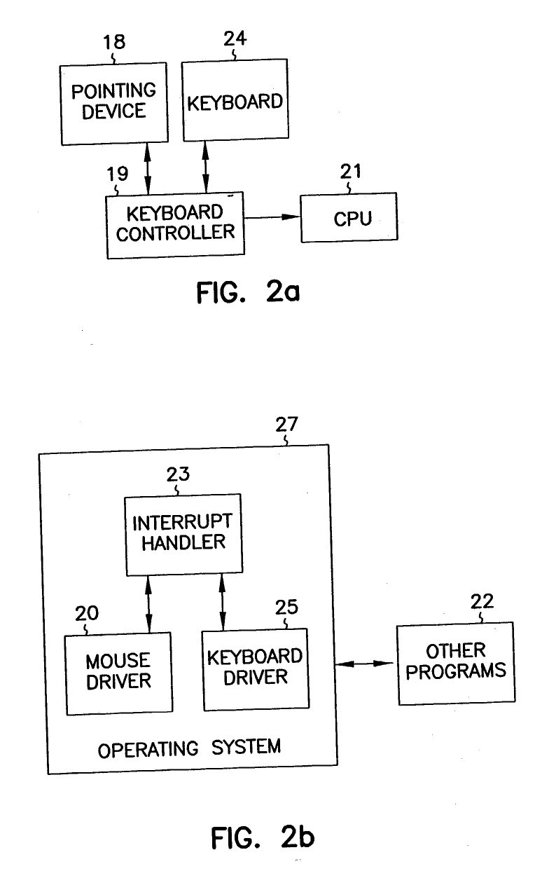

Referring now to FIG. 2(a), a block diagram of the hardware aspects of a computerized system according to an embodiment of the present invention is shown. Pointing device 18 (e.g., pointing device 16 of FIG. 1) and keyboard 24 (e.g., keyboard 12 of FIG. 1) are both operatively coupled to keyboard controller 19, which is itself operatively coupled to central-processing unit (CPU) 21. Keyboard controller 19 is an integrated circuit (IC), such as the Mitsubishi M-388-13M4, that controls pointing device 18 and keyboard 24. Keyboard controller 19 receives signals from pointing device 18 regarding whether the user has made a movement on pointing device 18, or has tapped pointing device 18. That is, keyboard controller 19 receives signals from pointing device 18 as to whether pointing device 18 has been actuated. Keyboard controller 19 also receives signals from keyboard 24 regarding whether a key on keyboard 24 has been actuated. Keyboard controller 19 sends an interrupt request (IRQ) or a system management interrupt (SMI) to CPU 21 upon receiving a signal from pointing device 18 or keyboard 24, as understood by those skilled in the art.

Referring now to FIG. 2(b), a block diagram of the software aspects of a computerized system according to an embodiment of the present invention is shown. Each of the blocks 20, 22, 23, 25 and 27 of FIG. 2(b) represents software, typically stored on the fixed storage device of the computer (such as a hard disk drive), and executed by the CPU of the computer as needed. The CPU also makes use of RAM as needed during the execution of the software. Any of the software represented by blocks 20, 22, 23, 25 and 27 may be stored on a computer-readable storage medium, such as a floppy disk, for transfer to another computer for installation.

Interrupt handler 23, pointing device driver 20, and keyboard driver 25 are part of operating system (OS) 27 of the computer. Pointing device driver 20 controls the signals received from the pointing device, and thus is the interface by which other computer programs 22 receive signals from the pointing device, as is understood by those skilled in the art. Other computer programs 22 use pointing device driver 20 to determine whether the user has made a movement on the pointing device, or has tapped the pointing device. Similarly, keyboard driver 25 controls the signals received from the keyboard, and thus is the interface by which other computer programs 22 receive signals from the keyboard, as is also understood by those skilled in the art. Other computer programs 22 use keyboard driver 25 to determine whether the user has pressed a key on the keyboard.

Interrupt handler 23 notifies pointing device driver 20 when an IRQ or SMI related to the actuation of the pointing device has been generated, and similarly notifies keyboard driver 25 when an IRQ or SMI related to the actuation of the keyboard has been generated. Therefore, both pointing device driver 20 and keyboard driver 25 are event-driven; they are executed only when an event in the form of an actuation of the keyboard or the pointing device has caused an IRQ or SMI to be generated. In the pointing device driver of the invention, the pointing device driver also receives notification from interrupt handler 23 when an IRQ or SMI related to the actuation of the keyboard has been generated.

The present invention provides for a pointing device driver to prevent unintended actuation of the pointing device from causing an event on the computer.

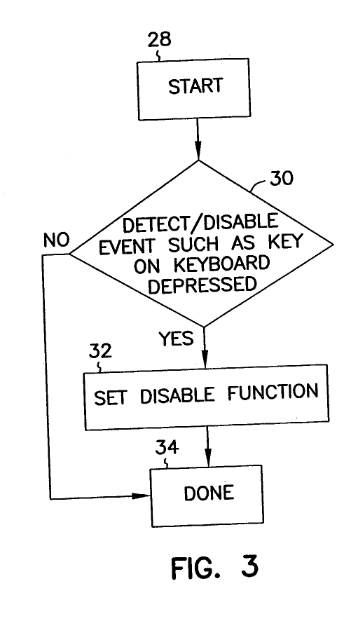

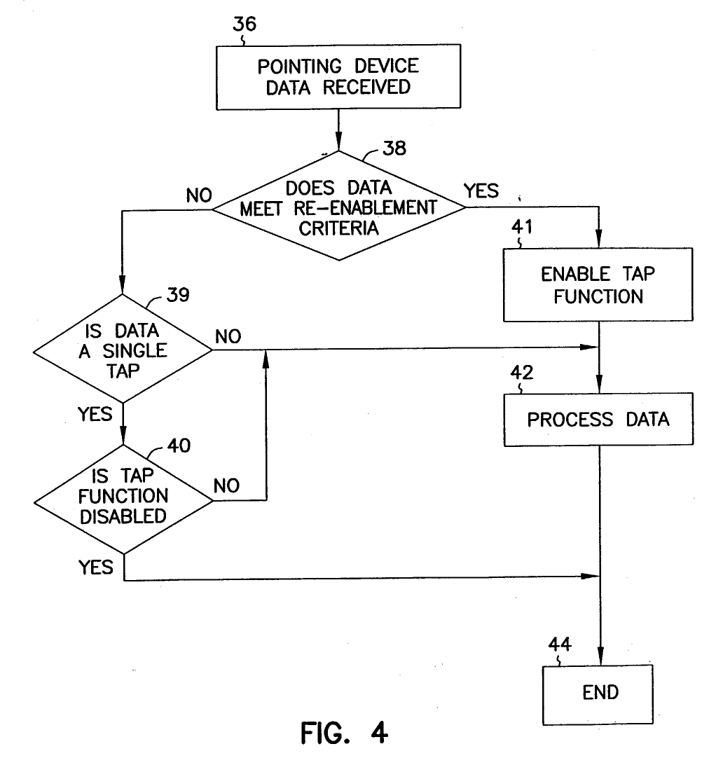

In one embodiment, the pointing device driver (e.g., driver 20 of FIG. 2(b)) of the present invention is effectuated by the flowcharts of FIG. 3 and FIG. 4. The functions shown in and described in conjunction with these figures in one embodiment are capable of being turned on and off by the user. That is, the user is able to turn off the feature of the present invention whereby unintended actuation of the pointing device is prevented from causing an event on the computer.

Referring now to FIG. 3, a flow chart of the disable tap function of a pointing device driver according to one embodiment of the invention is shown. The disable tap function of the pointing device driver is event-driven, preferably by an actuation of the keyboard generating an IRQ or SMI. Steps 28, 30, 32 and 34 of FIG. 3 make up a disable component of the driver. Control proceeds from the starting point of step 28 to step 30, at which step control proceeds to step 32 if a disabling event has been detected. In a preferred embodiment, the disabling event is the actuation of a key on the keyboard. The present invention is, however, not limited to any particular disabling event detected at step 30. For example, in another embodiment of the invention, the disabling event detected at step 30 is the activation of a text-entry mode of a computer program running on the computer (as has been already herein discussed) for at least a predetermined length of time, such as one second. The disabling event may also be any other event, such as a user-defined event.

Regardless of the event detected by step 30, once it has been detected, control proceeds to step 32, at which step a disable function (viz., a disable flag) is set. The setting of the disable function indicates that a single-tap actuation of the pointing device is to be ignored. That is, a single-tap actuation of the pointing device is not to be transmitted to the other computer programs (such as other computer programs 22 of FIG. 2) that rely on the pointing device driver for information regarding the pointing device. Control then proceeds from step 32 to step 34, at which step the disable tap function is finished. Control also proceeds to step 34 from step 30, if no event was detected at step 30.

Referring now to FIG. 4, a flow chart of the censoring and re-enable functions of a pointing device driver according to one embodiment of the invention is shown. The functions are event-driven, preferably by an actuation of the pointing device generating an SMI or IRQ. Steps 36, 38, 39, 40, 41, 42 and 44 make up a censor and re-enable component of the driver. When an input has been received from the touch pad at step 36, control proceeds to step 38. In differing embodiments of the invention, the actuation received at step 36 is a tap on the touch-sensitive pad of the pointing device (in the case where the device is a touch pad), a click on a button of the pointing device, or either a tap or a click.

In step 38, it is determined whether the pointing device data received in step 36 meets the re-enablement criteria. That is, in step 38 it is determined whether an enabling event has occurred. Detection of this event causes control to proceed to step 41. The invention is not limited to any particular enabling event. In one embodiment of the invention, the event is the passage of a predetermined length of time (such as one second) since a key on the keyboard has been depressed and detected in step 30 of FIG. 3. Other events include the user moving a finger (or equivalent) on the touch-sensitive pad more than a predetermined distance (such as a quarter inch, or a user-defined distance) in any direction, or the user double-tapping on the touch pad.

At step 41, the driver resets the disable function that had been previously set in step 32 of FIG. 3. This means that when data regarding a single tap is subsequently received in step 36, the tap is not ignored, but processed normally. From step 41, control proceeds to step 42, where the data regarding the actuation of the pointing device is processed normally, as those of ordinary skill within the art understand. For example, if the user has tapped the pointing device, the program currently active receives this information.

If in step 38 the enabling event has not occurred, control proceeds from step 38 to step 39. In step 39, the driver determines whether the data regarding the actuation of the pointing device received in step 36 represents a single tapping of the pointing device. If the actuation of the pointing device was a single tap, control proceeds to step 40. In step 40, the driver determines whether the disable function has been set (i.e., at step 32 of FIG. 3). If it has been, control proceeds to step 44, and the pointing device driver ignores the actuation detected; i.e., control proceeds to step 44, at which step the censoring and re-enable functions of FIG. 4 are finished. Conversely, if the disable function has not been set, control proceeds from step 40 to step 42, where the input received at step 36 is processed normally, as those of ordinary skill within the art understand.

As has been described, the present invention provides for controlling the actuation of a touch pad pointing device of a computer program, via a pointing device driver of an operating system, through which other programs running on the operating system obtain information regarding the pointing device. Thus, when the user has caused a disabling event to occur, such as by typing on a keyboard of the computer, the driver ignores single-tap actuations of the touch pad pointing device. That is, the driver does not indicate to the other programs that a single-tap actuation of the pointing device has been detected.

This means that events caused by unintended single-tap actuation of the touch pad pointing device are prevented. For example, if a user is typing and accidentally taps the pointing device while not running a driver program according to an embodiment of the present invention, the actuation of the pointing device is ignored by the pointing device driver. The driver only stops ignoring single-tap actuations of the pointing device when a enabling event has occurred, such as if the user has moved more than a predetermined distance on the touch pad in any direction.

As has been described, the present invention provides for the control of unintended single-tap actuation of a pointing device without inordinate effort on the part of the user, or inordinate decrease in the performance of the computer system. Those of ordinary skill in the art will readily appreciate that many changes and modifications to the above drawings and description can be made without departure from the spirit or scope of the following claims.

I claim:

1. A computerized system comprising:
a touch pad pointing device capable of actuation by a user; and,
a pointing device driver to ignore unintended single-tap actuation of the pointing device.
